(19) United States
(12) Patent Application Publication
(10) Pub. No.: US 2025/0269770 A1
(43) Pub. Date: Aug. 28, 2025

(54) SEAT SUPPORT ELEMENT COMPRISING EXTERNAL SHOCK ABSORBERS

(71) Applicant: Faurecia Sièges d'Automobile, Nanterre (FR)

(72) Inventors: Sébastien SEILLE, BRIIS-SOUS-FORGES (FR); Mounir EL FESSI, CACHAN (FR)

(21) Appl. No.: 19/066,138

(22) Filed: Feb. 27, 2025

(30) Foreign Application Priority Data
Feb. 28, 2024 (FR) FR2401972

(51) Int. Cl. B60N 2/16

(52) U.S. Cl. CPC B60N 2/1675; B60N 2/1665

(57) ABSTRACT

A seat support element having a base and a frame that is movable with respect to the base in an elevation direction, the base extending between two lateral lower edges extending in a longitudinal direction perpendicular to the elevation direction, the movable frame extending between two lateral upper edges extending in the longitudinal direction and facing the two lateral lower edges, respectively, in the elevation direction. The support element includes two shock absorbers each connecting one of the two lower lateral edges to the facing upper lateral edge, each shock absorber extending in an inclined direction forming a non-zero angle with the elevation direction.

### TECHNICAL FIELD

The present invention relates to a support element for a vehicle seat of the type comprising a fixed base that is intended to be fastened to the floor of the vehicle, and a movable frame that is movable with respect to the base in an elevation direction, the base extending between two lateral lower edges extending in a longitudinal direction perpendicular to the elevation direction and opposite one another in a transverse direction perpendicular to the elevation direction and to the longitudinal direction, the movable frame extending between two lateral upper edges extending in the longitudinal direction and opposite one another in the transverse direction, the two lateral upper edges extending facing the two lower lateral edges, respectively, in the elevation direction.

### BACKGROUND

The comfort of the seats for the occupants of a vehicle is of paramount importance for a user wishing to have a pleasant experience when using the vehicle.

In order to increase comfort, stability and shock absorption, it is known practice to provide a special seat support element to form part of the seat portion of the seat.

This support element is positioned directly under the seat, between the seat portion and the floor of the vehicle, and is used, for example, to allow the height of the seat to be adjusted to suit the occupant, to compensate for the weight of the occupant when they are sitting in the seat, or to absorb impacts for the occupant when the vehicle is in operation, for example driving on an uneven road surface.

To this end, it is known practice to place a shock absorber in the center of the support element, extending between a movable frame and a base of the support element, along an elevation direction, for example corresponding to a floor-ceiling direction in the vehicle, in order to filter out unevennesses in the road surface and prevent the propagation of impacts for the occupant.

However, the limited space available inside the vehicle is a constraint that must be observed by all of the components of the vehicle, including those designed for passenger comfort.

In particular, it is necessary to provide a support element of which the height, in the elevation direction, is minimal so as not to take up space in the passenger compartment of the vehicle, which is not the case with a shock absorber as described above.

### SUMMARY

One of the aims of the invention is thus to provide a vehicle seat support element for absorbing impacts of which the height is minimized.

To this end, one subject of the invention is a vehicle seat support element that comprises two shock absorbers each connecting one of the two lower lateral edges to the facing upper lateral edge, each shock absorber extending in an inclined direction forming a non-zero angle with the elevation direction.

Since the shock absorbers connect the movable frame to the base at an angle with respect to the elevation direction, it is possible to maintain a length of cushion that is satisfactory for absorbing jolts and preventing the propagation of impacts for the occupant, while limiting the height of the shock absorbers and therefore of the support element.

In this way, the height of the support element is minimal while ensuring the comfort of the occupant of the seat.

According to other advantageous aspects of the invention, the support element comprises one or more of the following features, taken alone or in any technically feasible combination:
each shock absorber extends in an inclined direction forming an angle with the elevation direction of between 10° and 80°, even more preferably between 30° and 60°, for example substantially equal to 60° in the position of the shock absorber that is most inclined with respect to the elevation direction;
each shock absorber comprises an upper end connected to the upper lateral edge and a lower end connected to the lower lateral edge, the connection of each end to the corresponding lateral edge being a pivot link about an axis of rotation extending in the transverse direction;
the two shock absorbers are arranged symmetrically in the support element with respect to a median plane perpendicular to the transverse direction and extending an equal distance from each of the lateral upper edges;
the two shock absorbers extend from a rear flank of the base to a front flank of the movable frame, the rear flank of the base being spaced apart from the front flank of the movable frame in the longitudinal direction;
the two shock absorbers are linear actuators such as pneumatic or hydraulic cylinders;
the support element comprises a movement system for moving the movable frame with respect to the base, the movement system being arranged between the movable frame and the base in the elevation direction and between each shock absorber in the transverse direction;
the movement system comprises at least one movement unit comprising a spring extending in the longitudinal direction and two crossed connecting bars each extending between an upper end attached to the movable frame by a pivot link and a lower end attached to the base by a pivot link, a free end of each spring being connected to the upper end of at least one connecting bar;
the support element comprises two movement units arranged symmetrically in the support element with respect to a median plane perpendicular to the transverse direction and extending an equal distance from each of the lateral upper edges;
the support element comprises a manual or motor-driven actuating device for moving the movable frame with respect to the base, the actuation of said actuating device causing compression or extension of the or each spring.

The invention also relates to a vehicle seat comprising a support element as claimed in any one of the preceding claims, the movable frame of the support element forming part of a seat portion of the seat which is movable in the elevation direction with respect to the base.

### BRIEF DESCRIPTION OF THE DRAWINGS

The invention will become clearer on reading the following description, given solely by way of non-limiting example, and made with reference to the drawings, wherein:

FIG. 1 schematically shows a vehicle seat comprising a support element according to an embodiment of the invention,

FIG. 2 is a perspective view of the support element of FIG. 1,

FIG. 3 is a perspective view of portions of the support element of FIG. 1, focusing on a system for moving the support element, and

FIG. 4 is a perspective view of portions of the support element of FIG. 1, focusing on a shock absorber of the support element.

### DETAILED DESCRIPTION

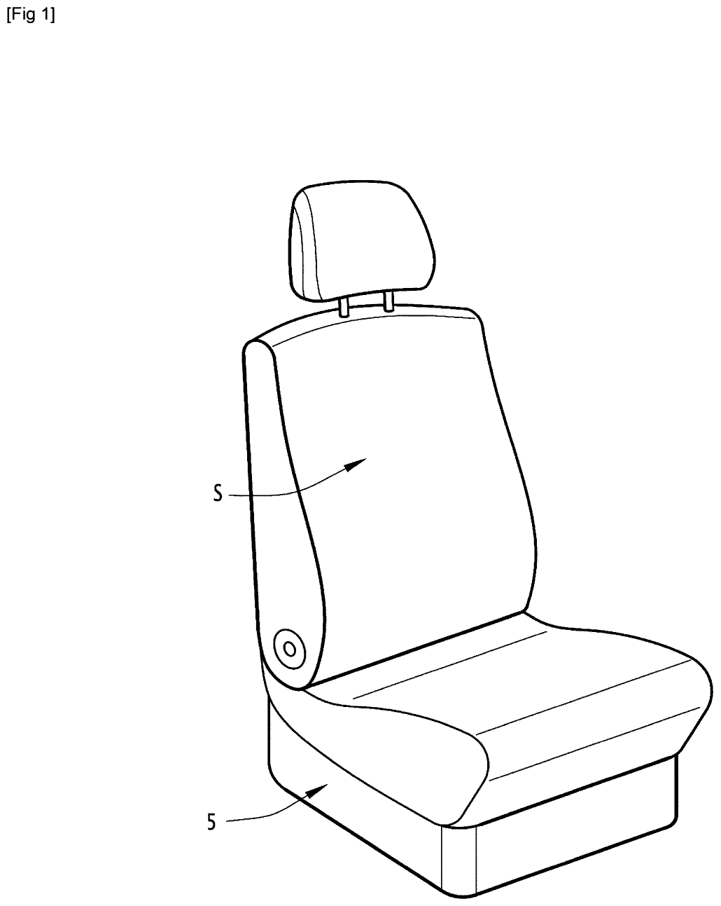

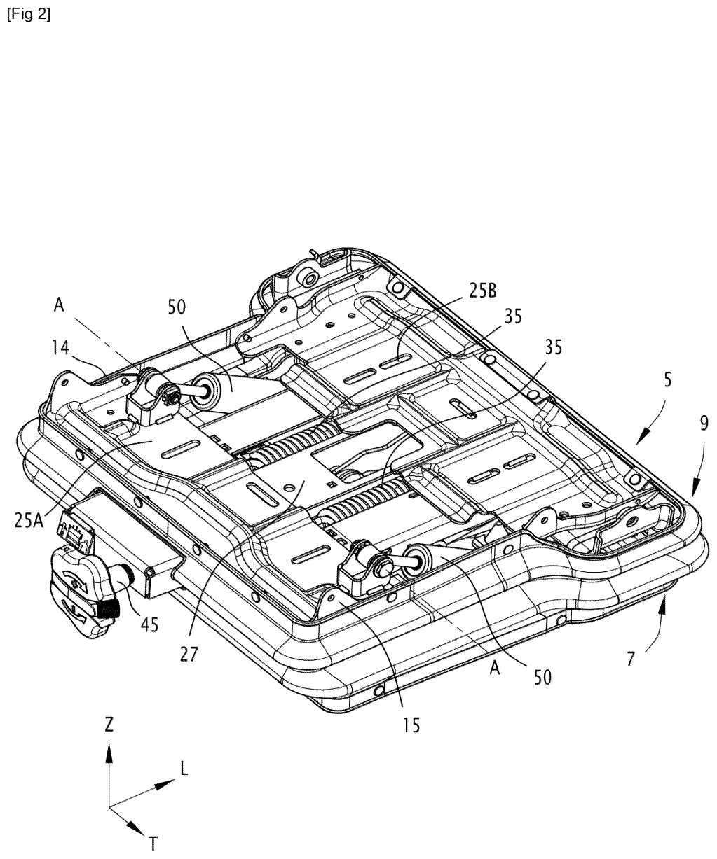

FIGS. 1 and 2 show a support element 5 for a vehicle seat S comprising a fixed base 7 and a movable frame 9 (these are visible in FIG. 2).

The base 7 is, for example, a base of the vehicle seat S, which base is intended to be mounted on the floor of the vehicle, for example by means of a system of slides allowing the seat S to be moving in a sliding direction which corresponds, for example, to a longitudinal direction L of the vehicle, that is to say the front-rear direction of the vehicle.

The movable frame 9 extends facing the lower portion 7 in an elevation direction Z, corresponding, for example, to the floor-ceiling direction of the vehicle, and is movable with respect to the base 7 in the elevation direction Z, so as to allow adjustment of the relative position of the movable frame 9 and of the base 7. Such an adjustment is a height adjustment of the position of the movable frame 9.

In one particular embodiment, illustrated in FIG. 1, the movable frame 9 forms part of a seat portion of the seat S in which an occupant of the seat sits when occupying the vehicle. In this case, the movable frame 9 is, for example, intended to be fitted with padding designed to accommodate the occupant of the seat S.

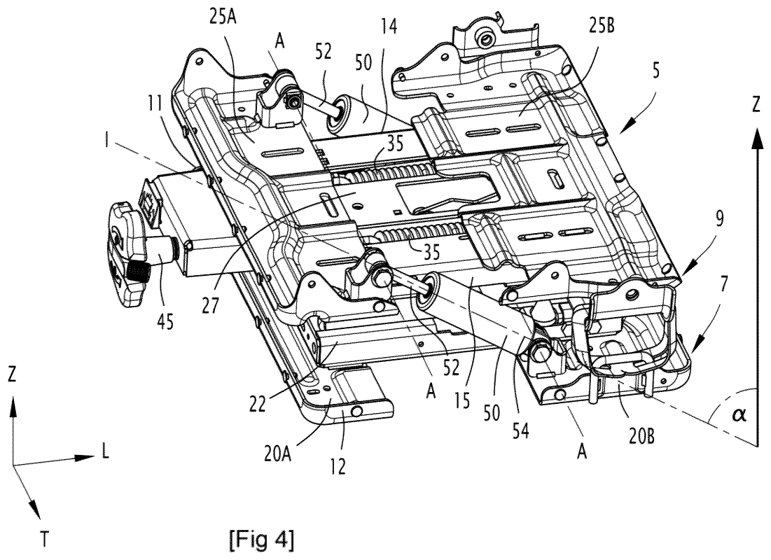

The base 7 extends between two lateral lower edges 11, 12 (these are visible only in FIG. 4), extending in the longitudinal direction L and spaced apart from one another in a transverse direction T perpendicular to the elevation direction Z and to the longitudinal direction L.

The transverse direction T corresponds, for example, to the left-right direction of the vehicle, or to the width of the vehicle.

Similarly, the movable frame 9 extends between two lateral upper edges 14, 15 (these are visible in FIGS. 2 and 4) extending in the longitudinal direction L and spaced apart from one another in the transverse direction T.

The two lateral upper edges 14, 15 extend facing the two lateral lower edges 11, 12, respectively, in the elevation direction Z.

According to the embodiment shown in FIG. 2, the base 7 is formed by a front flank 20A and a rear flank 20B, the front flank 20A and the rear flank 20B being spaced apart from one another in the longitudinal direction L and extending mainly in the transverse direction T. The two flanks 20A, 20B are, for example, secured to one another by at least one lower crossmember 22 extending in the longitudinal direction L.

In one variant (not shown), the base 7 is formed by a single flank.

The two lateral lower edges 11, 12 are then defined as all of the longitudinal edges of the flanks 20A, 20B and of the lower crossmember 22, i.e. the edges that extend in the longitudinal direction L and are spaced apart from one another in the transverse direction T.

In a similar manner, the movable frame 9 is, for example, formed by a front flank 25A and a rear flank 25B, the front flank 25A and the rear flank 25B extending mainly in the transverse direction T and being spaced apart from one another in the longitudinal direction L. The two flanks 25A, 25B are, for example, secured to one another by at least one upper crossmember 27 extending in the longitudinal direction L.

In particular, the movable frame 9 comprises any element that is movable, with respect to the base 7, in the elevation direction Z. Thus, the front flank 25A and the rear flank 25B, and the upper crossmember 27, are movable with respect to the base 7, in the elevation direction Z.

In one variant (not shown), the movable frame 9 is formed by a single flank.

The two lateral upper edges 14, 15 are then defined as all of the longitudinal edges of the flanks 25A, 25B and of the upper crossmember 27, i.e. the edges that extend in the longitudinal direction L and are spaced apart from one another in the transverse direction T.

The flanks 25A, 25B of the movable frame 9 extend at least partly facing the flanks 20A, 20B of the base 7 and are spaced apart therefrom by an adjustable distance in the elevation direction Z.

Similarly, the upper crossmember 27 extends at least partly facing the lower crossmember 22 and is spaced apart therefrom by an adjustable distance in the elevation direction Z.

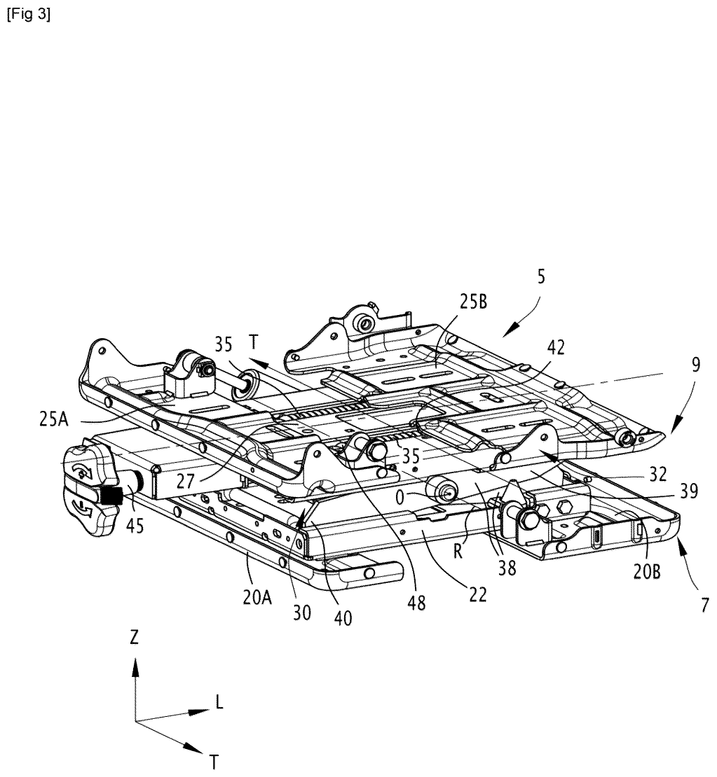

In one particular embodiment, and with reference to FIG. 3, the support element 5 comprises a movement system 30 for moving the movable frame 9 with respect to the base 7.

The movement system 30 is arranged to allow the movable frame 9 to be moved with respect to the base 7, for example in the elevation direction Z. In other words, according to the embodiment shown in the figures, the movement system 30 makes it possible to adjust the height of the seat portion of the seat S and/or to compensate for the weight of an occupant when they are seated in the seat S.

As shown in FIG. 3, the movement system 30 is arranged between the movable frame 9 and the base 7 in the elevation direction Z.

Preferably, the movement system 30 comprises at least one movement unit 32 comprising a spring 35 extending in the longitudinal direction L and two crossed connecting bars 38 each extending between an upper end 39 attached to the movable frame 9 by a pivot link and a lower end 40 attached to the base 7 by a pivot link.

Each pivot link extends, for example, substantially transversely, i.e. the rotation allowed by this pivot link is about an axis of rotation that extends in the transverse direction T.

In particular, the upper ends 39 of the connecting bars 38 are attached to the flanks 25A, 25B of the movable frame 9 by pivot links, and the lower ends 40 of the connecting bars 38 are attached to the flanks 20A, 20B of the base 7 by pivot links.

What is meant by “crossed” is that each connecting bar 38 connects a lateral upper edge 14, 15 to the lateral lower edge 11, 12, forming an X with the other connecting bar 38. In other words, along the longitudinal direction L, a first connecting bar 38 connects the lateral upper edge 14, 15 to the lateral lower edge 11, 12, and a second connecting bar 38 connects the lateral lower edge 11, 12 to the lateral upper edge 14, 15, the connecting bars crossing between these lower 11, 12 and upper 14, 15 lateral edges.

The two connecting bars 38 are fastened to one another at their center O and are rotatably movable with respect to one another along a transverse axis of rotation R that passes through the center O.

Thus, in a plane containing the elevation direction Z and the longitudinal direction L, the two connecting bars 38 form a non-zero angle with one another.

A first free end 42 of the spring is connected to the upper end 39 of at least one connecting bar 38.

In the example shown in FIGS. 2 to 4, the movement system 30 comprises two movement units 32 arranged symmetrically in the support element 5 with respect to a median plane perpendicular to the transverse direction T and extending an equal distance from each of the lateral upper edges 14, 15.

Preferably, the support element 5 comprises a manual or motor-driven actuating device 45 for moving the movable frame 9 with respect to base 7.

For example, the actuating device 45 is a knob manually rotated by a user. Alternatively, the actuating device 45 is a motor-driven device capable of compressing or releasing the or each spring 35 on command from a user.

The actuation of said actuating device 45 causes compression or extension of the or each spring 35.

To this end, the actuating device 45 is, for example, connected to a second free end 48 of the or each spring 35, opposite the first free end 42 of the or each spring 35 in the longitudinal direction L.

Thus, when the actuating device 45 is actuated, the or each spring 35 is compressed or extended, by pushing or pulling on the second free end 48 of the or each spring 35, and transmits the forces applied thereto to the crossed connecting bars 38.

By virtue of the pivot links attaching their upper ends 39 to the movable frame 9 and their lower ends 40 to the base 7, the connecting bars 38 are arranged so as to move with respect to one another, changing the angle formed between them, thereby moving the movable frame 9 with respect to the base 7 in the elevation direction Z.

In other words, the connecting bars 38 are rotated about the axis of rotation R and, via the pivot links at their upper ends 39, move the movable frame 9 in translation in the elevation direction Z.

The relative height, in the elevation direction Z, of the seat S is then set and adjusted by and/or for the occupant.

Similarly, when a user sits on the seat portion of the seat S formed, for example, by the movable frame 9 of the support element 5, the springs 35 are arranged so as to keep the connecting bars 38 immobile, i.e. to keep the angle they form between them fixed, so as not to move the movable frame 9 with respect to the base 7 when the user sits down.

Such a movement system 30 thus makes it possible to counterbalance the weight of the user sitting on the seat S, so that the seat S remains at the desired height.

With reference to FIG. 4, the support element 5 comprises two shock absorbers 50, each connecting one of the two lower lateral edges 11, 12 to the facing upper lateral edge 14, 15.

The presence of two shock absorbers 50 makes it possible to improve comfort for the occupant, and in particular reduces the vibrations transmitted by the vehicle to the occupant seated in the seat S.

Each shock absorber 50 extends in an inclined direction I forming a non-zero angle with the elevation direction Z.

In particular, each shock absorber 50 extends in an inclined direction I forming an angle α with the elevation direction Z of between 10° and 80°, even more preferably between 30° and 60°, for example substantially equal to 60° in the position of the shock absorber 50 that is most inclined with respect to the elevation direction Z as shown in FIG. 4.

Since the shock absorbers 50 extend at an angle rather than parallel to the elevation direction Z, they ensure optimum comfort for the occupant of the seat S because they retain a good, or better, length of cushion for compensating for impacts in the elevation direction Z caused by unevenness in the road surface, while minimizing the height required under the seat S to accommodate the support element 5.

The two shock absorbers 50 are, for example, linear actuators such as pneumatic, hydraulic or electric cylinders, capable of converting any kind of energy (e.g. from impacts due to uneven road surfaces) into mechanical translational energy. Thus, the shock absorbers 50 produce a dissipative movement, like a bounce, which propagates, as will be described later, to the occupant but remains comfortable for the occupant of the vehicle.

In the example of FIG. 4, each shock absorber 50 comprises an upper end 52 connected to the upper lateral edge 14, 15 and a lower end 54 connected to the lower lateral edge 11, 12.

In the embodiment shown in FIGS. 2 to 4, each shock absorber 50 extends from the rear flank 20B of the base 7 to the front flank 25A of the movable frame 9.

Alternatively (not shown), each shock absorber 50 extends from the front flank 20A of the base 7 to the rear flank 25B of the movable frame 9.

The connection of each end 52, 54 to the corresponding lateral edge 11, 12, 14, 15 is a pivot link about an axis of rotation A extending in the transverse direction T.

The pivot links allow each shock absorber 50 to be articulated with respect to the movable frame 9 and the base 7, so that each shock absorber 50 can transmit a linear movement into a translational movement of the movable frame 9 in the elevation direction Z.

Thus, in the same way as above, each shock absorber 50 is arranged so as to compress or extend in the inclined direction I when absorbing an impact, driving the movable frame 9 in translation in the elevation direction Z via the pivot links attaching the ends 52, 54 to the lateral edges 11, 12, 14, 15.

In addition, the pivot links allow each shock absorber 50 to be articulated with respect to the movable frame 9 and the base 7, so that each shock absorber 50 can adapt to the position of the movable frame 9 with respect to the base 7 when an occupant of the seat S adjusts the height of the movable frame 9.

Each shock absorber 50 has, for example, a length of cushion in the inclined direction I of between ±20 mm and ±40 mm.

In one particular embodiment, the two shock absorbers 50 are arranged symmetrically in the support element 5 with respect to a median plane perpendicular to the transverse direction T and extending an equal distance from each of the lateral upper edges 14, 15.

This symmetry allows the support element 5 to be stiffened in the transverse direction T, in order to improve comfort for the occupant and provide better stability for the support element 5.

In the embodiment illustrated in FIGS. 2 to 4, the movement system 30 is arranged between each shock absorber 50 in transverse direction T.

Since the shock absorbers 50 are arranged outside the movement system 30 in the transverse direction T, it is possible to integrate a standard movement system 30 into the support element 5. This makes it possible to reduce the costs in manufacturing the support element 5 which may, for example, reuse an existing movement system 30.

In addition, the seat S can have a completely satisfactory, conventional appearance while affording optimum comfort for the occupant of the vehicle, without particularly adding bulk to the support element 5.

In addition, the presence of two lateral shock absorbers 50 provides a greater safety margin in the crash and regulatory tests frequently carried out on vehicle components, and in particular on vehicle seats and/or seat supports.

Such a support element 5 has many advantages.

Since the shock absorbers 50 connect the movable frame 9 to the base 7 at an angle with respect to the elevation direction Z, it is possible to maintain a length of cushion that is satisfactory for absorbing jolts and preventing the propagation of impacts for the occupant, while limiting the height of the shock absorbers 50 and therefore of the support element 5.

In this way, the height of the support element 5 is minimal while ensuring the comfort of the occupants of the seats of the vehicle.

Furthermore, since the shock absorbers 50 are located outside the movement system 30 in the transverse direction T and are attached to the upper 9 and lower 7 portions of the support element 5, the shock absorbers 50 are completely independent of the movement system 30.

This allows existing, high-performance conventional movement systems 30 to be reused for integration into the support element 5, with the shock absorbers 50 added thereto. The cost of manufacturing the support element 5 is then reduced.

The lateral symmetry of the support element 5, in particular provided by the symmetry of the two shock absorbers 50, affords the support element greater stability and allows the support element 5 to be stiffened laterally in order to prevent any play that could prove uncomfortable for the occupant of the seat.

1. A support element for a vehicle seat comprising a fixed base that is intended to be fastened to the floor of the vehicle, and a movable frame that is movable with respect to the base in an elevation direction, the base extending between two lateral lower edges extending in a longitudinal direction perpendicular to the elevation direction and opposite one another in a transverse direction perpendicular to the elevation direction and to the longitudinal direction, the movable frame extending between two lateral upper edges extending in the longitudinal direction and opposite one another in the transverse direction, the two lateral upper edges extending facing the two lower lateral edges, respectively, in the elevation direction,
wherein the support element comprises two shock absorbers each connecting one of the two lower lateral edges to the facing upper lateral edge, each shock absorber extending in an inclined direction forming a non-zero angle with the elevation direction.

2. The support element as claimed in claim 1, wherein each shock absorber extends in an inclined direction forming an angle with the elevation direction of between 10° and 80°, even more preferably between 30° and 60°, for example substantially equal to 60° in the position of the shock absorber that is most inclined with respect to the elevation direction.

3. The support element as claimed in claim 1, wherein each shock absorber comprises an upper end connected to the upper lateral edge and a lower end connected to the lower lateral edge, the connection of each end to the corresponding lateral edge being a pivot link about an axis of rotation extending in the transverse direction.

4. The support element as claimed in claim 1, wherein the two shock absorbers are arranged symmetrically in the support element with respect to a median plane perpendicular to the transverse direction and extending an equal distance from each of the lateral upper edges.

5. The support element as claimed in claim 1, wherein the two shock absorbers extend from a rear flank of the base to a front flank of the movable frame, the rear flank of the base being spaced apart from the front flank of the movable frame in the longitudinal direction.

6. The support element as claimed in claim 1, wherein the two shock absorbers are linear actuators such as pneumatic or hydraulic cylinders.

7. The support element as claimed in claim 1, further comprising a movement system for moving the movable frame with respect to the base, the movement system being arranged between the movable frame and the base in the elevation direction and between each shock absorber in the transverse direction.

8. The support element as claimed in claim 7, wherein the movement system comprises at least one movement unit comprising a spring extending in the longitudinal direction and two crossed connecting bars each extending between an upper end attached to the movable frame by a pivot link and a lower end attached to the base by a pivot link, a free end of each spring being connected to the upper end of at least one connecting bar.

9. The support element as claimed in claim 8, further comprising two movement units arranged symmetrically in the support element with respect to a median plane perpendicular to the transverse direction and extending an equal distance from each of the lateral upper edges.

10. The support element as claimed in claim 8, further comprising a manual or motor-driven actuating device for moving the movable frame with respect to the base, the actuation of said actuating device causing compression or extension of the or each spring.

11. A vehicle seat comprising the support element as claimed in claim 1, the movable frame of the support element forming part of a seat portion of the seat which is movable in the elevation direction with respect to the base.
